(19) United States
(12) Patent Application Publication
(10) Pub. No.: US 2026/0025851 A1
(43) Pub. Date: Jan. 22, 2026

(54) DYNAMIC CHANNEL ACCESS MECHANISM FOR TXOP PREEMPTION

(71) Applicant: NOKIA TECHNOLOGIES OY, Espoo (FI)

(72) Inventors: Behnam Dezfouli, San Jose, CA (US); Klaus Franz Doppler, Albany, CA (US)

(21) Appl. No.: 18/779,755

(22) Filed: Jul. 22, 2024

(51) Int. Cl. H04W 74/0816

(52) U.S. Cl. CPC H04W 74/0816

(57) ABSTRACT

Methods and apparatuses are disclosed for determining stations (STAs) allowed to contend and/or preempt transmission opportunities (TXOPs), for structuring preemption opportunities (POs) into sub-windows and/or timeslots, and/or for dynamically adjusting parameters of POs.

### TECHNOLOGICAL FIELD

An example embodiment relates generally to dynamic channel access for transmission opportunity (TXOP) preemption.

### BACKGROUND

Some wireless technologies rely on low latency data exchange. In some examples, stations (STAs), for example, such as Wi-Fi STAs, may need to support applications relying on low latency data exchange. Thus, there is a need to reduce latency for STAs.

### BRIEF SUMMARY

Methods and apparatuses are disclosed for determining stations (STAs) allowed to contend and/or preempt transmission opportunities (TXOPs), for structuring preemption opportunities (POs) into sub-windows and/or timeslots, and/or for dynamically adjusting parameters of POs.

In an example embodiment, an apparatus is provided comprising at least one processor and at least one memory storing instructions that, when executed by the at least one processor, cause the apparatus at least to perform at least one of the following: (i) signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus; (ii) structuring a PO window into one or more sub-windows, wherein a sub-window comprises one or more timeslots, and wherein each timeslot is usable by a PES to preempt a TXOP; or (iii) dynamically adjusting, based on a collision intensity among the PESs, at least one of the following: the threshold for the AC_{TXOP}; a number of sub-windows; or a number of timeslots. In some examples, the apparatus is a TXOP holder. The instructions, when executed by the at least one processor, may further cause the apparatus to structure the PO window into one or more sub-windows by: (i) conveying, by the TXOP holder or an access point (AP), an access category (AC) threshold value ACTXOP to one or more STAs, wherein at least some of the one or more STAs are preemption-eligible STAs; and (ii) providing, by a TXOP holder or an AP, one or more preemption opportunities (POs) during a TXOP interval, wherein a PO is available to the PESs. The instructions, when executed by the at least one processor, may further cause the apparatus to dynamically adjust the number of sub-windows or timeslots by: (i) acquiring, by the TXOP holder, a channel based on detection of a collision by the TXOP holder; (ii) transmitting one or more frames; (iii) marking a next PO; and (determining a number of timeslots to be used by one or more STAs belonging to a plurality of PESs having an AC threshold value that is dependent on a number x of a timeslot in which a collision is detected, wherein the AC threshold value dependent on the number x is AC_{TXOP+X}. The instructions, when executed by the at least one processor, may further cause the apparatus to determine one or more STAs as PESs by: (i) determining, based on a relationship of an AC of one or more packets of a STA to a threshold AC value set for at least a portion of a duration of a TXOP, that the STA is a PES; (ii) determining whether one or more STAs belong to plurality of PESs during a PO based on an AC announced by a TXOP holder or an AP and/or an AC associated with traffic to be transmitted; and (iii) preempting, by the PES, the TXOP.

In an example embodiment, a method is provided that comprises at least one of the following: (i) signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus; (ii) structuring a PO window into one or more sub-windows, wherein a sub-window comprises one or more timeslots, and wherein each timeslot is usable by a PES to preempt a TXOP; or (iii) dynamically adjusting, based on a collision intensity among the PESs, at least one of the following: the threshold for the AC_{TXOP}; a number of sub-windows; or a number of timeslots. In some examples, the apparatus is a TXOP holder. The method may further comprise structuring the PO window into one or more sub-windows by: (i) conveying, by the TXOP holder or an access point (AP), an access category (AC) threshold value AC_{TXOP} to one or more STAs, wherein at least some of the one or more STAs are preemption-eligible STAs; and (ii) providing, by a TXOP holder or an AP, one or more preemption opportunities (POs) during a TXOP interval, wherein a PO is available to the PESs. The method may further comprise dynamically adjusting the number of sub-windows or timeslots by: (i) acquiring, by the TXOP holder, a channel based on detection of a collision by the TXOP holder; (ii) transmitting one or more frames; (iii) marking a next PO; and (determining a number of timeslots to be used by one or more STAs belonging to a plurality of PESs having an AC threshold value that is dependent on a number x of a timeslot in which a collision is detected, wherein the AC threshold value dependent on the number x is AC_{TXOP+X}. The method may further comprise determining one or more STAs as PESs by: (i) determining, based on a relationship of an AC of one or more packets of a STA to a threshold AC value set for at least a portion of a duration of a TXOP, that the STA is a PES; (ii) determining whether one or more STAs belong to plurality of PESs during a PO based on an AC announced by a TXOP holder or an AP and/or an AC associated with traffic to be transmitted; and (iii) preempting, by the PES, the TXOP.

In an example embodiment, an apparatus further comprises means for at least one of the following: (i) signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus; (ii) structuring a PO window into one or more sub-windows, wherein a sub-window comprises one or more timeslots, and wherein each timeslot is usable by a PES to preempt a TXOP; or (iii) dynamically adjusting, based on a collision intensity among the PESs, at least one of the following: the threshold for the AC_{TXOP}; a number of sub-windows; or the number of timeslots. In some examples, the apparatus is a TXOP holder. The apparatus may further comprise means for structuring the PO window into one or more sub-windows by: (i) conveying, by the TXOP holder or an access point (AP), an access category (AC) threshold value ACTXOP to one or more STAs, wherein at least some of the one or more STAs are preemption-eligible STAs; and (ii) providing, by a TXOP holder or an AP, one or more preemption opportunities (POs) during a TXOP interval, wherein a PO is available to the PESs. The apparatus may further comprise means for dynamically adjusting the number of sub-windows or timeslots by: (i) acquiring, by the TXOP holder, a channel based on detection of a collision by the TXOP holder; (ii) transmitting one or more frames; (iii) marking a next PO; and determining a number of timeslots to be used by one or more STAs belonging to a plurality of PESs having an AC threshold value that is dependent on a number x of a timeslot in which a collision is detected, wherein the AC threshold value dependent on the number x is AC_{TXOP+X}. The apparatus may further comprise means for determining one or more STAs as PESs by: (i) determining, based on a relationship of an AC of one or more packets of a STA to a threshold AC value set for at least a portion of a duration of a TXOP, that the STA is a PES; (ii) determining whether one or more STAs belong to plurality of PESs during a PO based on an AC announced by a TXOP holder or an AP and/or an AC associated with traffic to be transmitted; and (iii) preempting, by the PES, the TXOP.

In an example embodiment, a non-transitory computer readable storage medium is provided comprising computer instructions that, when executed by an apparatus, cause the apparatus to perform at least one of the following: (i) signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus; (ii) structuring a PO window into one or more sub-windows, wherein a sub-window comprises one or more timeslots, and wherein each timeslot is usable by a PES to preempt a TXOP; or (iii) dynamically adjusting, based on a collision intensity among the PESs, at least one of the following: the threshold for the AC_{TXOP}; a number of sub-windows; or a number of timeslots. In some examples, the apparatus is a TXOP holder. The computer instructions may further comprise computer instructions that, when executed by the apparatus, cause the apparatus to structure the PO window into one or more sub-windows by: (i) conveying, by the TXOP holder or an access point (AP), an access category (AC) threshold value ACTXOP to one or more STAs, wherein at least some of the one or more STAs are preemption-eligible STAs; and (ii) providing, by a TXOP holder or an AP, one or more preemption opportunities (POs) during a TXOP interval, wherein a PO is available to the PESs. The computer instructions may further comprise computer instructions that, when executed by the apparatus, cause the apparatus to dynamically adjust the number of sub-windows or timeslots by: (i) acquiring, by the TXOP holder, a channel based on detection of a collision by the TXOP holder; (ii) transmitting one or more frames; (iii) marking a next PO; and (determining a number of timeslots to be used by one or more STAs belonging to a plurality of PESs having an AC threshold value that is dependent on a number x of a timeslot in which a collision is detected, wherein the AC threshold value dependent on the number x is AC_{TXOP+X}. The computer instructions may further comprise computer instructions that, when executed by the apparatus, cause the apparatus to determine one or more STAs as PESs by: (i) determining, based on a relationship of an AC of one or more packets of a STA to a threshold AC value set for at least a portion of a duration of a TXOP, that the STA is a PES; (ii) determining whether one or more STAs belong to plurality of PESs during a PO based on an AC announced by a TXOP holder or an AP and/or an AC associated with traffic to be transmitted; and (iii) preempting, by the PES, the TXOP.

In an example embodiment, an apparatus is provided comprising at least one processor and at least one memory storing instructions that, when executed by the at least one processor, cause the apparatus at least to perform: (i) conveying, by a transmission opportunity (TXOP) holder or access point (AP), an access category (AC) threshold value AC_{TXOP} to one or more other stations (STAs), wherein at least some of the one or more STAs are preemption-eligible STAs (PESs); and (ii) providing, by a TXOP holder or an AP, one or more preemption opportunities (POs) during a TXOP interval, wherein the PO is available to the PESs. In some examples, the PESs among the one or more other STAs are determined based on the AC_{TXOP} and the determining is performed by the TXOP holder or the AP based on received information or by the one or more STAs. In some examples, a maximum AC is AC_{MAX} and wherein one or more POs include AC_{MAX}−AC_{TXOP}+1 sub-windows. In some examples, one or more PESs determine, based on their AC values, which sub-window can be used for TXOP preemption. In some examples, one or more of the AC_{MAX}−AC_{TXOP}+1 sub-windows are not equal to one another. In some examples, one or more of the AC_{MAX}−AC_{TXOP}+1 sub-windows include one or more time slots for channel access contention. In some examples, one or more of the AC_{MAX}−AC_{TXOP}+1 sub-windows are used by STAs having packets whose AC corresponds to the one or more of the AC_{MAX}−AC_{TXOP}+1 sub-windows. The instructions, when executed by the at least one processor, may further cause the apparatus to calculate a number of sub-windows in one or more POs based on at least one of the following: (i) the TXOP holder and/or the AP conveying AC_{TXOP} to the one or more other STAs; or (ii) the one or more other STAs having an indication of AC_{MAX}. The instructions, when executed by the at least one processor, may further cause the apparatus to select one or more time slots in one or more sub-windows based on a priority and/or amount of buffered data. In some examples, the TXOP holder is configured to announce a highest AC of its traffic as the AC_{TXOP}. In some examples, an access point (AP) is configured to announce and enforce the AC_{TXOP} to be followed by all STAs by including such an announcement in beacon frames. The instructions, when executed by the at least one processor, may further cause the apparatus to: (i) acquire, by the TXOP holder, a channel; (ii) transmit one or more frames; (iii) mark a next PO; and (iv) determine, based on detection by the TXOP holder of a collision, a number of sub-windows and/or a number of time slots to be used by one or more STAs belonging to a plurality of PESs having an AC threshold value that is dependent on a number x of a time slot in which a collision is detected, wherein the AC threshold value dependent on the number x is AC_{TXOP+X}. In some examples, the instructions, when executed by the at least one processor, further cause the apparatus to set a lowest AC threshold value AC_{TXOP} that can be used for transmissions by the PESs.

In an example embodiment, a method is provided that comprises: (i) conveying, by a transmission opportunity (TXOP) holder or access point (AP), an access category (AC) threshold value AC_{TXOP} to one or more other stations (STAs), wherein at least some of the one or more STAs are preemption-eligible STAs (PESs); and (ii) providing, by a TXOP holder or an AP, one or more preemption opportunities (POs) during a TXOP interval, wherein the PO is available to the PESs. In some examples, the PESs among the one or more other STAs are determined based on the AC_{TXOP} and the determining is performed by the TXOP holder or the AP based on received information or by the one or more STAs. In some examples, a maximum AC is AC_{MAX} and wherein one or more POs include AC_{MAX}−AC_{TXOP}+1 sub-windows. In some examples, one or more PESs determine, based on their AC values, which sub-window can be used for TXOP preemption. In some examples, one or more of the AC_{MAX}−AC_{TXOP}+1 sub-windows are not equal to one another. In some examples, one or more of the AC_{MAX}−AC_{TXOP}+1 sub-windows include one or more time slots for channel access contention. In some examples, one or more of the AC_{MAX}−AC_{TXOP}+1 sub-windows are used by STAs having packets whose AC corresponds to the one or more of the AC_{MAX}−AC_{TXOP}+1 sub-windows. The method may further comprise calculating a number of sub-windows in one or more POs based on at least one of the following: (i) the TXOP holder and/or the AP conveying AC_{TXOP} to the one or more other STAs; or (ii) the one or more other STAs having an indication of AC_{MAX}. The method may further comprise selecting one or more time slots in one or more sub-windows based on a priority and/or amount of buffered data. In some examples, the TXOP holder is configured to announce a highest AC of its traffic as the AC_{TXOP}. In some examples, an access point (AP) is configured to announce and enforce the AC_{TXOP} to be followed by all STAs by including such an announcement in beacon frames. The method may further comprise: (i) acquiring, by the TXOP holder, a channel; (ii) transmitting one or more frames; (iii) marking a next PO; and (iv) determining, based on detection by the TXOP holder of a collision, a number of sub-windows and/or a number of time slots to be used by one or more STAs belonging to a plurality of PESs having an AC threshold value that is dependent on a number x of a time slot in which a collision is detected, wherein the AC threshold value dependent on the number x is AC_{TXOP+X}. The method may further comprise setting a lowest AC threshold value AC_{TXOP} that can be used for transmissions by the PESs.

In an example embodiment, an apparatus further comprises means for: (i) conveying, by a transmission opportunity (TXOP) holder or access point (AP), an access category (AC) threshold value AC_{TXOP} to one or more other stations (STAs), wherein at least some of the one or more STAs are preemption-eligible STAs (PESs); and (ii) providing, by a TXOP holder or an AP, one or more preemption opportunities (POs) during a TXOP interval, wherein the PO is available to the PESs. In some examples, the PESs among the one or more other STAs are determined based on the AC_{TXOP} and the determining is performed by the TXOP holder or the AP based on received information or by the one or more STAs. In some examples, a maximum AC is AC_{MAX} and wherein one or more POs include AC_{MAX}−AC_{TXOP}+1 sub-windows. In some examples, one or more PESs determine, based on their AC values, which sub-window can be used for TXOP preemption. In some examples, one or more of the AC_{MAX}−AC_{TXOP}+1 sub-windows are not equal to one another. In some examples, one or more of the AC_{MAX}−AC_{TXOP}+1 sub-windows include one or more time slots for channel access contention. In some examples, one or more of the AC_{MAX}−AC_{TXOP}+1 sub-windows are used by STAs having packets whose AC corresponds to the one or more of the AC_{MAX}−AC_{TXOP}+1 sub-windows. The apparatus may further comprise means for calculating a number of sub-windows in one or more POs based on at least one of the following: (i) the TXOP holder and/or the AP conveying AC_{TXOP} to the one or more other STAs; or (ii) the one or more other STAs having an indication of AC_{MAX}. The apparatus may further comprise means for selecting one or more time slots in one or more sub-windows based on a priority and/or amount of buffered data. In some examples, the TXOP holder is configured to announce a highest AC of its traffic as the AC_{TXOP}. In some examples, an access point (AP) is configured to announce and enforce the AC_{TXOP} to be followed by all STAs by including such an announcement in beacon frames. The apparatus may further comprise means for: (i) acquiring, by the TXOP holder, a channel; (ii) transmitting one or more frames; (iii) marking a next PO; and (iv) determining, based on detection by the TXOP holder of a collision, a number of sub-windows and/or a number of time slots to be used by one or more STAs belonging to a plurality of PESs having an AC threshold value that is dependent on a number x of a time slot in which a collision is detected, wherein the AC threshold value dependent on the number x is AC_{TXOP+X}. The apparatus may further comprise means for setting a lowest AC threshold value AC_{TXOP} that can be used for transmissions by the PESs.

In an example embodiment, a non-transitory computer readable storage medium is provided comprising computer instructions that, when executed by an apparatus, cause the apparatus to: (i) convey, by a transmission opportunity (TXOP) holder or access point (AP), an access category (AC) threshold value AC_{TXOP} to one or more other stations (STAs), wherein at least some of the one or more STAs are preemption-eligible STAs (PESs); and (ii) provide, by a TXOP holder or an AP, one or more preemption opportunities (POs) during a TXOP interval, wherein the PO is available to the PESs. In some examples, the PESs among the one or more other STAs are determined based on the AC_{TXOP} and the determining is performed by the TXOP holder or the AP based on received information or by the one or more STAs. In some examples, a maximum AC is AC_{MAX} and wherein one or more POs include AC_{MAX}−AC_{TXOP}+1 sub-windows. In some examples, one or more PESs determine, based on their AC values, which sub-window can be used for TXOP preemption. In some examples, one or more of the AC_{MAX}−AC_{TXOP}+1 sub-windows are not equal to one another. In some examples, one or more of the AC_{MAX}−AC_{TXOP}+1 sub-windows include one or more time slots for channel access contention. In some examples, one or more of the AC_{MAX}−AC_{TXOP}+1 sub-windows are used by STAs having packets whose AC corresponds to the one or more of the AC_{MAX}−AC_{TXOP}+1 sub-windows. The computer instructions may further comprise computer instructions that, when executed by the apparatus, cause the apparatus to calculate a number of sub-windows in one or more POs based on at least one of the following: (i) the TXOP holder and/or the AP conveying AC_{TXOP} to the one or more other STAs; or (ii) the one or more other STAs having an indication of AC_{MAX}. The computer instructions may further comprise computer instructions that, when executed by the apparatus, cause the apparatus to select one or more time slots in one or more sub-windows based on a priority and/or amount of buffered data. In some examples, the TXOP holder is configured to announce a highest AC of its traffic as the AC_{TXOP}. In some examples, an access point (AP) is configured to announce and enforce the AC_{TXOP} to be followed by all STAs by including such an announcement in beacon frames. The computer instructions may further comprise computer instructions that, when executed by the apparatus, cause the apparatus to: (i) acquire, by the TXOP holder, a channel; (ii) transmit one or more frames; (iii) mark a next PO; and (iv) determine, based on detection by the TXOP holder of a collision, a number of sub-windows and/or a number of time slots to be used by one or more STAs belonging to a plurality of PESs having an AC threshold value that is dependent on a number x of a time slot in which a collision is detected, wherein the AC threshold value dependent on the number x is AC_{TXOP+X}. The computer instructions may further comprise computer instructions that, when executed by the apparatus, cause the apparatus to set a lowest AC threshold value AC_{TXOP} that can be used for transmissions by the PESs.

In an example embodiment, an apparatus is provided comprising at least one processor and at least one memory storing instructions that, when executed by the at least one processor, cause the apparatus at least to perform: (i) acquiring, by a transmission opportunity (TXOP) holder, a channel based on detection of a collision by the TXOP holder; (ii) transmitting one or more frames; (iii) marking a next preemption opportunity (PO); and (iv) determining a number of sub-windows and/or a number of time slots to be used by one or more stations (STAs) belonging to a plurality of preemption-eligible STAs (PESs) having an access category (AC) threshold value that is dependent on a number x of a time slot in which a collision is detected, wherein the AC threshold value dependent on the number x is AC_{TXOP+X}. In some examples, the detection of the collision is based on a start time of signal arrival indicating a type of traffic that the one or more STAs belonging to the plurality of PESs are trying to send. The instructions, when executed by the at least one processor, may further cause the apparatus to: (i) determine, by the TXOP holder, that a collision occurred in a sub-window associated with AC_{TXOP+X}; (ii) increase, by the TXOP holder, AC_{TXOP} to AC_{TXOP+X}; and (iii) allocate, by the TXOP holder, an entire PO duration to AC_{TXOP}+x or allocate, by the TXOP holder, an entire PO duration to AC_{MAX}−AC_{TXOP+X}+1 sub-windows. In some examples, an access point (AP) is configured to determine the number of timeslots based on a number of the one or more STAs and on an amount of traffic belonging to one or more ACs based on at least one of: buffer status reports (BSRs) or traffic exchange history. In some examples, the one or more STAs belonging to the plurality of PESs are configured to calculate a number of time slots per sub-window based on a total number of time slots in a current PO being known. In some embodiments, a total number of timeslots in one or more POs is determined by at least one of the following: (i) the TXOP holder; (ii) the AP; or (iii) based on a fixed number of values depending on number of STAs, traffic type, and/or traffic rate. The instructions, when executed by the at least one processor, may further cause the apparatus to determine, by the TXOP holder, a highest AC of one or more competing STAs based on a start time of detecting a signal or packet on the channel.

In an example embodiment, a method is provided that comprises: (i) acquiring, by a transmission opportunity (TXOP) holder, a channel based on detection of a collision by the TXOP holder; (ii) transmitting one or more frames; (iii) marking a next preemption opportunity (PO); and (iv) determining a number of sub-windows and/or a number of time slots to be used by one or more stations (STAs) belonging to a plurality of preemption-eligible STAs (PESs) having an access category (AC) threshold value that is dependent on a number x of a time slot in which a collision is detected, wherein the AC threshold value dependent on the number x is AC_{TXOP+X}. In some examples, the detection of the collision is based on a start time of signal arrival indicating a type of traffic that the one or more STAs belonging to the plurality of PESs are trying to send. The method may further comprise: (i) determining, by the TXOP holder, that a collision occurred in a sub-window associated with AC_{TXOP+X}; (ii) increasing, by the TXOP holder, AC_{TXOP} to AC_{TXOP+X}; and (iii) allocating, by the TXOP holder, an entire PO duration to AC_{TXOP+X} or allocating, by the TXOP holder, an entire PO duration to AC_{MAX}−AC_{TXOP+X}+1 sub-windows. In some examples, an access point (AP) is configured to determine the number of timeslots based on the number of STAs and on an amount of traffic belonging to one or more ACs based on at least one of: buffer status reports (BSRs) or traffic exchange history. In some examples, the one or more STAs belonging to the plurality of PESs are configured to calculate a number of time slots per sub-window based on a total number of time slots in a current PO being known. In some examples, a total number of timeslots in one or more POs is determined by at least one of the following: (i) the TXOP holder; (ii) the AP; or (iii) based on a fixed number of values depending on number of STAs, traffic type, and/or traffic rate. The method further comprises determining, by the TXOP holder, a highest AC of one or more competing STAs based on a start time of detecting a signal or packet on the channel.

In an example embodiment, an apparatus further comprises means for: (i) acquiring, by a transmission opportunity (TXOP) holder, a channel based on detection of a collision by the TXOP holder; (ii) transmitting one or more frames; (iii) marking a next preemption opportunity (PO); and (iv) determining a number of sub-windows and/or a number of time slots to be used by one or more stations (STAs) belonging to a plurality of preemption-eligible STAs (PESs) having an access category (AC) threshold value that is dependent on a number x of a time slot in which a collision is detected, wherein the AC threshold value dependent on the number x is AC_{TXOP+X}. In some examples, the detection of the collision is based on a start time of signal arrival indicating a type of traffic that the one or more STAs belonging to the plurality of PESs are trying to send. The apparatus may further comprise means for: (i) determining, by the TXOP holder, that a collision occurred in a sub-window associated with AC_{TXOP+X}; (ii) increasing, by the TXOP holder, AC_{TXOP} to AC_{TXOP+X}; and (iii) allocating, by the TXOP holder, an entire PO duration to AC_{TXOP+X} or allocating, by the TXOP holder, an entire PO duration to AC_{MAX}−AC_{TXOP+X}+1 sub-windows. In some examples, an access point (AP) is configured to determine the number of timeslots based on the number of STAs and on an amount of traffic belonging to one or more ACs based on at least one of: buffer status reports (BSRs) or traffic exchange history. In some examples, the one or more STAs belonging to the plurality of PESs are configured to calculate a number of time slots per sub-window based on a total number of time slots in a current PO being known. In some examples, a total number of timeslots in one or more POs is determined by at least one of the following: (i) the TXOP holder; (ii) the AP; or (iii) based on a fixed number of values depending on number of STAs, traffic type, and/or traffic rate. The apparatus may further comprise means for determining, by the TXOP holder, a highest AC of one or more competing STAs based on a start time of detecting a signal or packet on the channel.

In an example embodiment, a non-transitory computer readable storage medium is provided comprising computer instructions that, when executed by an apparatus, cause the apparatus to: (i) acquire, by a transmission opportunity (TXOP) holder, a channel based on detection of a collision by the TXOP holder; (ii) transmit one or more frames; (iii) mark a next preemption opportunity (PO); and (iv) determine a number of sub-windows and/or a number of time slots to be used by one or more stations (STAs) belonging to a plurality of preemption-eligible STAs (PESs) having an access category (AC) threshold value that is dependent on a number x of a time slot in which a collision is detected, wherein the AC threshold value dependent on the number x is AC_{TXOP+X}. In some examples, the detection of the collision is based on a start time of signal arrival indicating a type of traffic that the one or more STAs belonging to the plurality of PESs are trying to send. The computer instructions may further comprise computer instructions that, when executed by the apparatus, cause the apparatus to: (i) determine, by the TXOP holder, that a collision occurred in a sub-window associated with AC_{TXOP+X}; (ii) increase, by the TXOP holder, AC_{TXOP} to AC_{TXOP+X}; and (iii) allocate, by the TXOP holder, an entire PO duration to AC_{TXOP+X} or allocate, by the TXOP holder, an entire PO duration to AC_{MAX}−AC_{TXOP+X}+1 sub-windows. In some examples, an access point (AP) is configured to determine the number of timeslots based on the number of STAs and on an amount of traffic belonging to one or more ACs based on at least one of: buffer status reports (BSRs) or traffic exchange history. In some examples, the one or more STAs belonging to the plurality of PESs are configured to calculate a number of time slots per sub-window based on a total number of time slots in a current PO being known. In some examples, a total number of timeslots in one or more POs is determined by at least one of the following: (i) the TXOP holder; (ii) the AP; or (iii) based on a fixed number of values depending on number of STAs, traffic type, and/or traffic rate. The computer instructions may further comprise computer instructions that, when executed by the apparatus, cause the apparatus to determine, by the TXOP holder, a highest AC of one or more competing STAs based on a start time of detecting a signal or packet on the channel.

In an example embodiment, an apparatus is provided comprising at least one processor and at least one memory storing instructions that, when executed by the at least one processor, cause the apparatus at least to perform: (i) determining, based on a relationship of an access category (AC) of one or more packets of a station (STA) to a threshold AC value (AC_{TXOP}) set for at least a portion of a duration of a transmission opportunity (TXOP), that the STA is a preemption-eligible STA (PES); (ii) determining whether the apparatus belongs to a plurality of PESs during a preemption opportunity (PO) based on: the threshold AC AC_{TXOP} announced by a TXOP holder or an access point (AP); or an AC associated with traffic to be transmitted by the apparatus; and (iii) preempting, by the apparatus, the TXOP. The instructions, when executed by the at least one processor, may further cause the apparatus to promote an AC or priority level associated with traffic based on slack time of packet delivery being reduced. The instructions, when executed by the at least one processor, may further cause the apparatus to: (i) acquire, by the TXOP holder, a channel based on detection of a collision by the TXOP holder; (ii) transmit one or more frames; and (iii) determine a number of timeslots to be used by one or more STAs belonging to a plurality of PESs having an AC threshold value that is dependent on a number x of a time slot in which a collision is detected, wherein the AC threshold value dependent on the number x is AC_{TXOP+X}.

In an example embodiment, a method is provided that comprises: (i) determining, based on a relationship of an access category (AC) of one or more packets of a station (STA) to a threshold AC value (AC_{TXOP}) set for at least a portion of a duration of a transmission opportunity (TXOP), that the STA is a preemption-eligible STA (PES); (ii) determining whether the apparatus belongs to a plurality of PESs during a preemption opportunity (PO) based on: the threshold AC AC_{TXOP} announced by a TXOP holder or an access point (AP); or an AC associated with traffic to be transmitted by the apparatus; and (iii) preempting, by the apparatus, the TXOP. The method may further comprise promoting an AC or priority level associated with traffic based on slack time of packet delivery being reduced. The method may further comprise: (i) acquiring, by the TXOP holder, a channel based on detection of a collision by the TXOP holder; (ii) transmitting one or more frames; and (iii) determining a number of timeslots to be used by one or more STAs belonging to a plurality of PESs having an AC threshold value that is dependent on a number x of a time slot in which a collision is detected, wherein the AC threshold value dependent on the number x is AC_{TXOP+X}.

In an example embodiment, an apparatus further comprises means for: (i) determining, based on a relationship of an access category (AC) of one or more packets of a station (STA) to a threshold AC value (AC_{TXOP}) set for at least a portion of a duration of a transmission opportunity (TXOP), that the STA is a preemption-eligible STA (PES); (ii) determining whether the apparatus belongs to a plurality of PESs during a preemption opportunity (PO) based on: the threshold AC AC_{TXOP} announced by a TXOP holder or an access point (AP); or an AC associated with traffic to be transmitted by the apparatus; and (iii) preempting, by the apparatus, the TXOP. The apparatus may further comprise means for promoting an AC or priority level associated with traffic based on slack time of packet delivery being reduced. The apparatus may further comprise means for: (i) acquiring, by the TXOP holder, a channel based on detection of a collision by the TXOP holder; (ii) transmitting one or more frames; and (iii) determining a number of timeslots to be used by one or more STAs belonging to a plurality of PESs having an AC threshold value that is dependent on a number x of a time slot in which a collision is detected, wherein the AC threshold value dependent on the number x is AC_{TXOP+X}.

In an example embodiment, a non-transitory computer readable storage medium is provided comprising computer instructions that, when executed by an apparatus, cause the apparatus to: (i) determine, based on a relationship of an access category (AC) of one or more packets of a station (STA) to a threshold AC value (AC_{TXOP}) set for at least a portion of a duration of a transmission opportunity (TXOP), that the STA is a preemption-eligible STA (PES); (ii) determine whether the apparatus belongs to a plurality of PESs during a preemption opportunity (PO) based on: the threshold AC AC_{TXOP} announced by a TXOP holder or an access point (AP); or an AC associated with traffic to be transmitted by the apparatus; and (iii) preempt, by the apparatus, the TXOP. The computer instructions may further comprise computer instructions that, when executed by the apparatus, cause the apparatus to promote an AC or priority level associated with traffic based on slack time of packet delivery being reduced. The computer instructions further comprise computer instructions that, when executed by the apparatus, cause the apparatus to: (i) acquire, by the TXOP holder, a channel based on detection of a collision by the TXOP holder; (ii) transmit one or more frames; and (iii) determine a number of timeslots to be used by one or more STAs belonging to a plurality of PESs having an AC threshold value that is dependent on a number x of a time slot in which a collision is detected, wherein the AC threshold value dependent on the number x is AC_{TXOP+X}.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a diagram of an example communication system;

FIG. 2 is a block diagram of an apparatus that may be specifically configured in accordance with an example embodiment of the present disclosure;

FIG. 3 is a representation of a transmission opportunity (TXOP);

FIG. 4 is an example of a station (STA) increasing an access category (AC) and/or priority of its data;

FIG. 5 is a representation of a preemption opportunity (PO) comprising sub-windows comprising timeslots;

FIG. 6 is an example of a TXOP during which sub-windows vary responsive to varying ACs;

FIG. 7 is an example of sub-window selection;

FIG. 8 is an example of sub-window selection;

FIG. 9 is a set of example equations for selecting a timeslot in a sub-window;

FIG. 10 is a representation of adjusting the number of sub-windows dynamically based on collision intensity;

FIG. 11 is an example collision scenario;

FIG. 12 is an example method implemented by one or more apparatuses described herein.

FIG. 13 is an example method implemented by one or more apparatuses described herein;

FIG. 14 is an example method implemented by one or more apparatuses described herein; and

FIG. 15 is an example method implemented by one or more apparatuses described herein, in accordance with an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with example embodiments of the present disclosure. Thus, use of any such terms should not be taken to limit the spirit and scope of example embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

A communications system may be deployed in a wireless local area network (WLAN or Wi-Fi)), for example, based on IEEE 802.11 standards and/or related drafts, such as 802.11-2020, 802.11ac, 802.11ax, 802.11be, and/or 802.11bn. That is, the system may be an example of a WLAN system. The WLAN system may support wireless communications between one or more communications devices in accordance with one or more Wi-Fi protocols. In some examples, Wi-Fi communications may occur via one or more radio frequency bands, such as about 2.4 GHz radio frequency band and/or about 5 GHz radio frequency band. In some such examples, each radio frequency band may support one or more channels over which data may be communicated. In some examples, multiple devices may use multiple channels to communicate over the WLAN concurrently.

A WLAN system may include one or more communications devices, such as one or more access points (APs) and/or one or more stations (STAs). That is, a device configured to support one or more Wi-Fi protocols may be an example of an AP (e.g., may operate in accordance with an AP mode) and/or may be an example of a STA (e.g., may operate in accordance with a STA mode). In some examples, an AP may control Wi-Fi communications for one or more STAs. For example, an AP may be (or may be connected to) a central device used to establish (and control) one or more connections between one or more STAs and another network (e.g., the Internet). In other words, in some examples, the AP may connect a wired network (e.g., the internet) to a wireless network (e.g., the WLAN). In some instances, a Wi-Fi network may be identified via one or more identifiers, such as a service set identifier (SSID).

A WLAN system may support one or more architectures (types of logical relationships between devices). For example, a WLAN may support an autonomous architecture, a centralized architecture, and a cooperative architecture. In some examples of an autonomous architecture, APs are stand-alone APs configured with features and capabilities to operate without any reliance on another device. In some examples of a centralized architecture, a centralized controller may regulate the operation of the WLAN. For example, the centralized controller may be a hardware device that is either wired to the APs (e.g., at the network edge), or uses a wireless system to provide local connection to clients (e.g., STAs). In other words, the controller may be the AP or may be wired to one or more APs within the WLAN. In some examples of a cooperative architecture (also referred to as a controller-less architecture), a virtual management (cloud-based) system may be used to control a WLAN. For example, the virtual management system may employ a cooperative communication method between one or more Aps to control the WLAN.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more STAs (also referred to as clients) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a STA) via data packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, a WLAN system may implement one or more security protocols to protect the confidentiality, integrity, and availability of Wi-Fi communications.

A transmission opportunity (TXOP) is a MAC feature in IEEE 802.11. TXOPs are configured to increase throughput, such as for high priority data, by providing contention-free channel access for a period of time. TXOP is available in a quality of service (QOS) mode as part of Enhanced Distributed Channel Access (EDCA), and it is a limited time period of contention-free channel access available to the channel-owning station (e.g., the TXOP holder). During such a period the STA may send multiple frames that belong to a particular access category. An advantage of TXOP is that it may increase throughput and/or reduce delay of QoS data frames by eliminating contention periods between transmissions. TXOP may be used in combination with aggregation and block acknowledgement to further increase throughput.

In some examples, access categories have different channel access parameters, for example, such as Arbitration Interframe Spacing (AIFS), duration, contention window size, and TXOP limit. In an example EDCA orthogonal frequency division multiplexing (OFDM) parameter of the IEEE 802.11 standard, these values are set so that higher priority packets are favored (e.g., the MAC waits less before sending them, the contention window is smaller, they can be sent in a TXOP, etc.). A STA may send frames to multiple recipients during a TXOP. In addition to QoS data frames, other frames can be exchanged in the course of the TXOP, such as ACK and BlockAckReq/BlockAck frames, and/or other control and management frames.

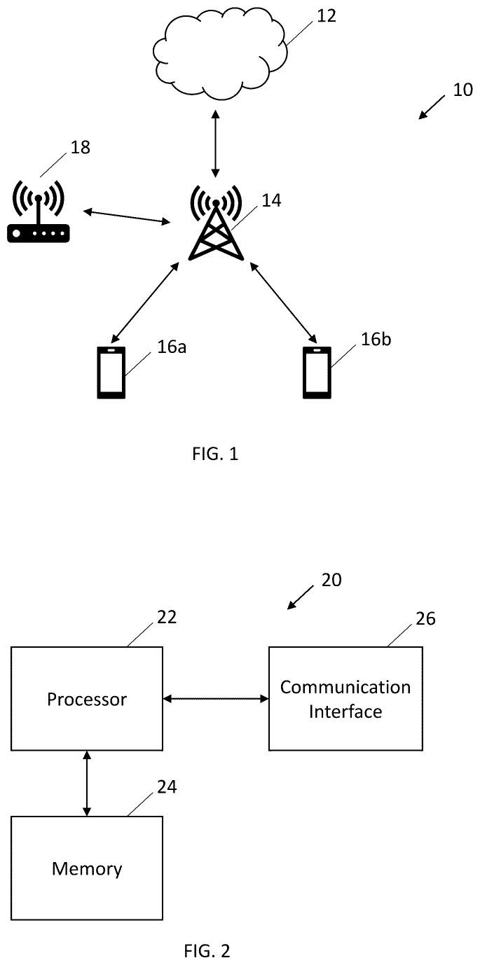

One example of a communications system 10 in which an example embodiment may be deployed is depicted in FIG. 1. The system of FIG. 1 may be utilized for a variety of applications. For example, a communications system 10 may include at least one core network 12, at least one distribution system (DS), at least one base station 14 (e.g., gNB, NodeB, etc.), at least one Wi-Fi access point (AP) 18, and/or at least one user device 16 (16a, b, . . . . N) (e.g., user equipment (UE), wireless device, user terminal, terminal device, station, etc.). The base station may be a mobile access point (mAP) wherein a user device may be an access point with limited functionality. In some examples, the configuration comprising the mAP and a user device may be implemented as part of a peer-to-peer connection, for example, such as in Wi-Fi Direct.

Wireless communication systems may include access points that provide wireless connectivity according to the Wi-Fi standards, which are a subset of the IEEE 802 family of standards. For example, the medium access control (MAC) and physical layer (PHY) specifications for Wi-Fi access points are defined by IEEE 802.11 for transmitting and receiving data in frequency bands such as infrared, 2.4 gigahertz (GHz), 3.6 GHz, 5 GHz, 60 GHz, and the like. Wi-Fi access points may transmit one or more frames. For example, the one or more frames may include data frames, management frames, and/or control frames, which may be transmitted in unicast messages, broadcast messages, or multicast messages. The 802.11 standards define an inter-frame space (IFS) as the nominal time (in microseconds, μs) that the medium access control (MAC) and physical layer (PHY) require in order to receive the last symbol of a frame, process the frame, and respond with the first symbol of the earliest possible response frame.

In FIG. 1, user devices 16a and 16b are configured to be in a wireless connection on one or more communication channels in a cell with one or more access nodes (such as a NodeB) 14, such as a NodeB which is used hereinafter by way of example to represent an access node. The user devices 16a and 16b are configured to be in a wireless connection with at least one Wi-Fi AP 18. The physical link from a user device to a NodeB is called the uplink or reverse link and the physical link from the NodeB to the user device is called the downlink or forward link. It should be appreciated that the NodeBs or their functionalities may be implemented by using any node, host, server, base station, Wi-Fi access point (AP) (e.g., such as the Wi-Fi AP 18), mobile AP, and/or other entity suitable for such a usage.

In some examples, the communications system 10 may support radiofrequency sensing during IFS. In some examples, the communications system 10 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The controller may include a processor (e.g., such as the processor 22) and a memory (e.g., such as the memory 24). The processor may be used to execute instructions stored in the memory and/or to store information in the memory, for example, such as the results of the executed instructions.

The Wi-Fi AP 18 may include a transceiver for transmitting and/or receiving signals, for example, over a backbone and/or over an air interface. The transceiver may be implemented as a single integrated circuit (e.g., using a single ASIC or FPGA) or as a SOC that includes different modules for implementing the functionality of the transceiver. The Wi-Fi AP 18 may further include a processor (e.g., such as the processor 22) and a memory (e.g., such as the memory 24) (see FIG. 2). The processor may be used to execute instructions stored in the memory and/or to store information in the memory, for example, such as the results of the executed instructions.

A communications system typically comprises more than one NodeB, in which case the NodeBs may also be configured to communicate with one another over links, wired or wireless. These links may be used for signaling purposes. The NodeB is a computing device which may be configured to control resources of the communication system to which the NodeB is coupled. The NodeB may also be referred to as a base station, an access point, a mobile AP, or any other type of interfacing device including a relay station capable of operating in a wireless environment.

The user device illustrates one type of an apparatus to which resources on the air interface are allocated and assigned, and thus any feature described herein with a user device may be implemented with a corresponding apparatus, such as the apparatus of FIG. 2.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device (such as a television, set-top-box, etc.). It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device is configured to perform one or more of user equipment functionalities. The user device may also be called a subscriber unit, mobile station, station (STA), remote terminal, access terminal, user terminal or user equipment (UE) just to mention but a few names or apparatuses.

The method and apparatus of an example embodiment may be utilized in conjunction with various communication systems, such as 5G, 5G-Advanced, 6G, IEEE 802.11ax, IEEE 802.11be, IEEE 802.11bn also referred to as Wi-Fi 6, 7, 8, and/or the like. A 5G system enables using multiple input-multiple output (MIMO) antennas, many more base stations or nodes than a Long Term Evolution (LTE) system (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. A 5G system may have various radio interfaces, namely below 6 GHz, cmWave and mmWave, and also being integratable with existing legacy radio access technologies, such as LTE. Integration with an LTE system may be implemented, at least in the early phase, as a system, where macro coverage is provided by an LTE system and 5G radio interface access comes from small cells by aggregation to the LTE system. In other words, a 5G system is planned to support both inter-radio access technology (RAT) operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in a 5G system require bringing the content close to the radio which leads to local break out and multi-access edge computing (MEC). A 5G system enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), and critical communications (autonomous vehicles, traffic safety, real-time analytics, time-critical control, and healthcare applications).

The communication system 10 is also able to communicate with other networks, such as a public switched telephone network or the Internet, or utilize services provided by them. The communication network 10 may also be able to support the usage of cloud services, for example at least part of core network operations may be carried out as a cloud service. The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side and non-real time functions being carried out in a centralized manner).

It should also be understood that the distribution of labor between core network operations and base station operations may differ from that of LTE or even be non-existent. Some other technology advancements that may be used are Big Data and all-IP, which may change the way networks are being constructed and managed. 5G (or new radio, NR) networks are being designed to support multiple hierarchies, where MEC servers can be placed between the core and the base station or nodeB (e.g., gNB). It should be appreciated that MEC can be applied in 4G networks as well.

5G systems may also utilize satellite communication to enhance or complement the coverage of 5G service, for example by providing backhauling. Possible use cases are providing service continuity for machine-to-machine (M2M) or Internet of Things (IoT) devices or for passengers on board vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system may be an example of a part of a radio access system in which the system 10 of FIG. 1 may be deployed and in practice, the system may comprise a plurality of NodeBs, the user devices may have access to a plurality of radio cells and the system may comprise also other apparatuses, such as physical layer relay nodes or other network elements, etc. At least one of the NodeBs or may be a Home NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The NodeBs of FIG. 1 may provide any kind of these cells. A cellular radio system may be implemented as a multilayer network including several kinds of cells. Typically, in multilayer networks, one access node provides one kind of a cell or cells, and thus a plurality of NodeBs is required to provide such a network structure.

For fulfilling the need for improving the deployment and performance of communication systems, the concept of “plug-and-play” NodeBs has been introduced. Typically, a network which is able to use “plug-and-play” Node Bs, includes, in addition to Home NodeBs (HnodeBs), a home node B gateway, or HNB-GW. A HNB Gateway (HNB-GW), which is typically installed within an operator's network may aggregate traffic from a large number of HNBs back to a core network. Although FIG. 1 depicts one example communication system in which system 10 of an example embodiment may be deployed, the system of other example embodiments may be deployed in other types of systems, be they to support communications or otherwise.

One example of an apparatus 20 that may be configured to function as the core network 12, base station 14, and/or user device 16 is depicted in FIG. 2. As shown in FIG. 2, the apparatus includes, is associated with or is in communication with a processor 22, a memory 24 and a communication interface 26. The processor may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present disclosure. For example, the memory device could be configured to buffer input data for processing by the processor. Additionally or alternatively, the memory device could be configured to store instructions for execution by the processor.

FIG. 2 depicts an example of a simplified block diagram of an apparatus according to various embodiments of the present disclosure, whose implementation may differ from what is shown. The connections shown in FIG. 2 are logical connections; the actual physical connections may be different. It is apparent to a person skilled in the art that the system typically comprises also other functions and structures than those shown in FIG. 2.

The apparatus 20 may, in some embodiments, be embodied in various computing or communication devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 22 may be embodied in a number of different ways. For example, the processor 22 may be implemented by processing circuitry. For example, the processor may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 22 may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present disclosure while configured accordingly. Thus, for example, when the processor is embodied as an ASIC, FPGA or the like, the processor may be specifically configured hardware for conducting the operations described herein. Alternatively or additionally, as another example, when the processor is embodied as an executor of instructions, the instructions may specifically configure the processor to perform the algorithms and/or operations described herein when the instructions are executed. However, in some cases, the processor 22 may be a processor of a specific device (e.g., an image or video processing system) configured to employ an embodiment of the present disclosure by further configuration of the processor by instructions for performing the algorithms and/or operations described herein. The processor 22 may include, among other things, a clock, an arithmetic logic unit (ALU) and logic gates configured to support operation of the processor.

The communication interface 26 may be any means such as a device or circuitry embodied in either hardware or a combination of hardware and software that is configured to receive and/or transmit data, including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some examples, the apparatus 20 may be an access point (AP) or a station (STA) (e.g., such as a user equipment) usable in a Wi-Fi network operating in accordance with IEEE 802.11 standards. In some examples, a transmission opportunity (TXOP) may be a time interval during which a station (STA), which could be either an access point (AP) or a non-AP STA, has the right to initiate transmissions on the wireless medium. In some examples, a transmission opportunity (TXOP) holder may be a STA that has gained the right to access the wireless medium for a certain period. In some examples, a preemption opportunity (PO) may be a specific time interval within a TXOP during which some STAs are allowed to contend for channel access. In some examples, an access category (AC) may be a classification used to prioritize different types of traffic within a network. In some examples, an AC may be referred to as a priority and/or priority level. In some examples, at least one AC (e.g., each AC) may have a unique priority level.

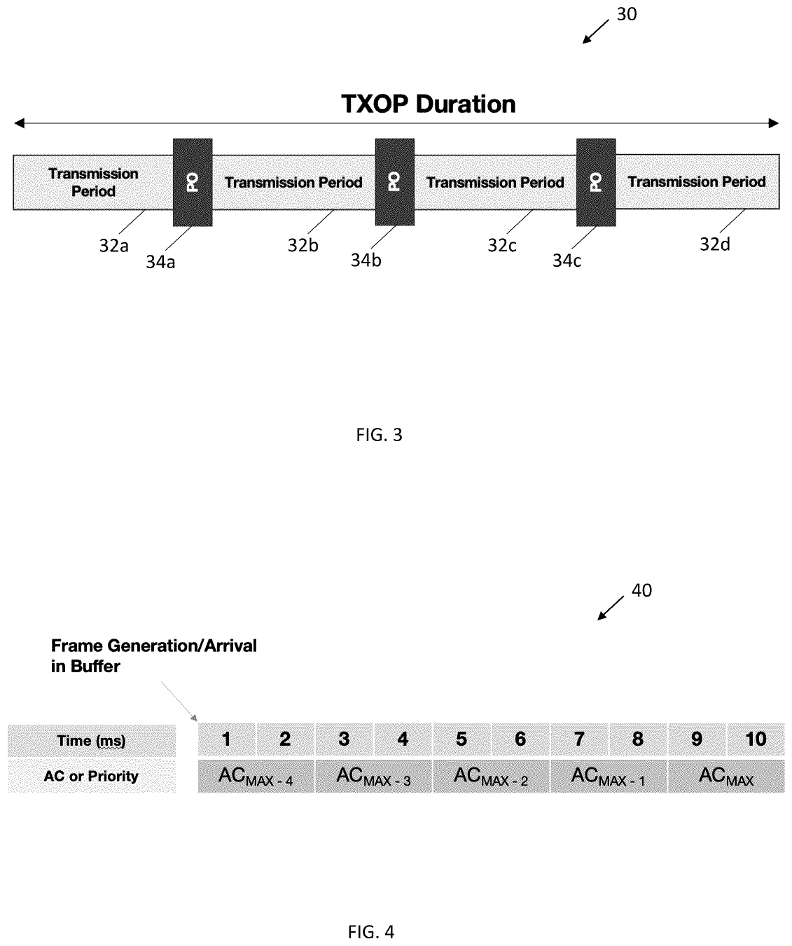

Referring now to FIG. 3, a representation of a TXOP 30 is provided. The TXOP 30 may be a TXOP duration (e.g., a time interval). TXOPs may be comprised of various types of time intervals, including transmission periods, POs, and/or other types of time intervals. The TXOP 30 may be comprised of the transmission periods 32a, 32b, 32c, and 32d. The TXOP 30 may further be comprised of the POs 34a, 34b, and 34c. TXOPs may be comprised of one or more transmission periods and/or one or more POs.

In some examples, a method for determining a set of preemption-eligible STAS (PESs) is provided. PESs may be a set of STAs (e.g., one or more STAs) allowed to contend and/or preempt a TXOP. A TXOP holder may be a STA having control of a TXOP. The TXOP holder may set and/or announce a lowest AC threshold value AC_{TXOP} to be used by PESs. In some examples, if the TXOP holder plans to transmit various ACs during the TXOP, the TXOP holder may use the highest AC of its traffic as the announced AC_{TXOP}. The TXOP holder may announce a higher or lower AC_{TXOP} compared to an actual AC of the traffic the TXOP holder may exchange during the transmission period. A maximum AC may be referred to as AC_{MAX}.

In some examples, alternatively or additionally, an access point (AP) may announce and/or enforce the AC_{TXOP} value to be followed by one or more STAs. For example, the AP may announce and/or enforce the AC_{TXOP} value by indicating the AC_{TXOP} value in beacon frames.

In some examples, announcing one or more forthcoming POs may be variously implemented. For example, forthcoming POs may be announced at the beginning of the TXOP. In another example, forthcoming POs may be announced at the beginning of one or more transmission periods (e.g., each transmission period). In some examples, announcements may be included as additional fields embedded into frame formats. In some examples, announcements may be transmitted via new frame formats.

In some examples, STAs having AC values greater than or equal to the AC value of the TXOP holder may utilize the POs to compete for preemption. Such STAs may be PESs. In some examples, the STAs (e.g., one or more STAs) which are PESs may change during the TXOP duration and/or during at least one TXOP (e.g., each TXOP). In some examples, one or more STAs may be determined to be PESs based on at least one of the following: (1) the AC announced by the TXOP holder during a transmission period preceding the PO, and/or (2) the AC of the traffic the one or more STAs may transmit.

In some examples, the TXOP holder and/or other STAs (e.g., PESs, non-PES STAs, and/or the like) may be enabled to promote and/or demote the AC of their traffic over time. In some examples, the TXOP holder and/or other STAs (e.g., PESs, non-PES STAs, and/or the like) may be enabled to promote and/or demote the priority level of their traffic over time. In some examples, “AC” and “priority” may be used interchangeably.

Referring now to FIG. 4, an example 40 of a STA increasing an AC (e.g., priority) of its data is provided. The example 40 represents a STA that must deliver its data to an AP within 10 ms. As the slack time of packet delivery (e.g., the deadline minus the current time) decreases, the STA increases the AC of its data. As shown in FIG. 4, as time progresses from 1 ms to 10 ms, the AC_{MAX} value increases; every 2 ms, the AC of the frames is increased. Such dynamic AC updating may provide various advantages, including dynamically changing the PESs during TXOPs and changing the AC_{TXOP} per transmission period and/or PO by the TXOP holder.

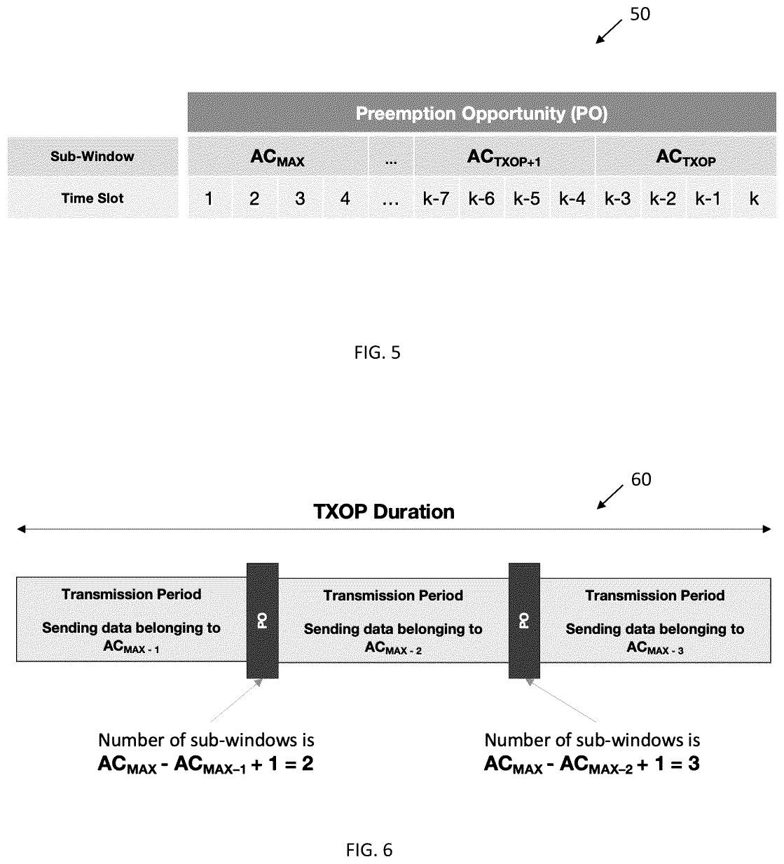

In some examples, a method for channel access during POs is provided. This method may be performed by a STA (e.g. the TXOP holder or an AP). For example, a PO (e.g., each PO) may include AC_{MAX}−AC_{TXOP}+1 sub-windows. The duration of the sub-windows may or may not be equal. A sub-window (e.g., each sub-window) may include one or more time slots for channel access contention. Referring now to FIG. 5 is a representation of a PO 50 comprising sub-windows comprising timeslots. For example, as shown in FIG. 5, each timeslot may represent one timeslot (e.g., in μseconds) for channel access contention.

The total number of time slots per PO may be announced by the TXOP holder at the beginning of each transmission period. The announced number may be applied to all the POs, some of the POs, or only one PO (e.g., the next PO). Alternatively, such information may be announced before each PO.

The TXOP holder may not need to convey the number of sub-windows to STAs. For example, if a TXOP is acquired, the TXOP holder may convey AC_{TXOP} to other STAs through the quality of service (QOS) field of its first frame. Such information may be conveyed via other fields and/or frame types. In some examples, one or more STAs (e.g., all STAs) may be aware of AC_{MAX}, which may allow the one or more STAs to calculate the number of sub-windows in each PO.

As the AC of the data sent by the TXOP holder during at least one transmission period (e.g., each transmission period) may change, the number of sub-windows per PO may change during a TXOP interval. Referring now to FIG. 6, an example of a TXOP 60 during which sub-windows vary responsive to varying ACs is provided. The TXOP 60 may comprise one or more transmission periods and/or one or more POs. The one or more transmission periods may be associated with a certain AC value, wherein data packets having that AC value may be transmitted during the corresponding transmission period. The number of sub-windows in the one or more POs may thus depend on the AC values, which may vary by transmission period. Thus, in FIG. 6, the lefthand PO may have two sub-windows and the righthand PO may have three sub-windows.

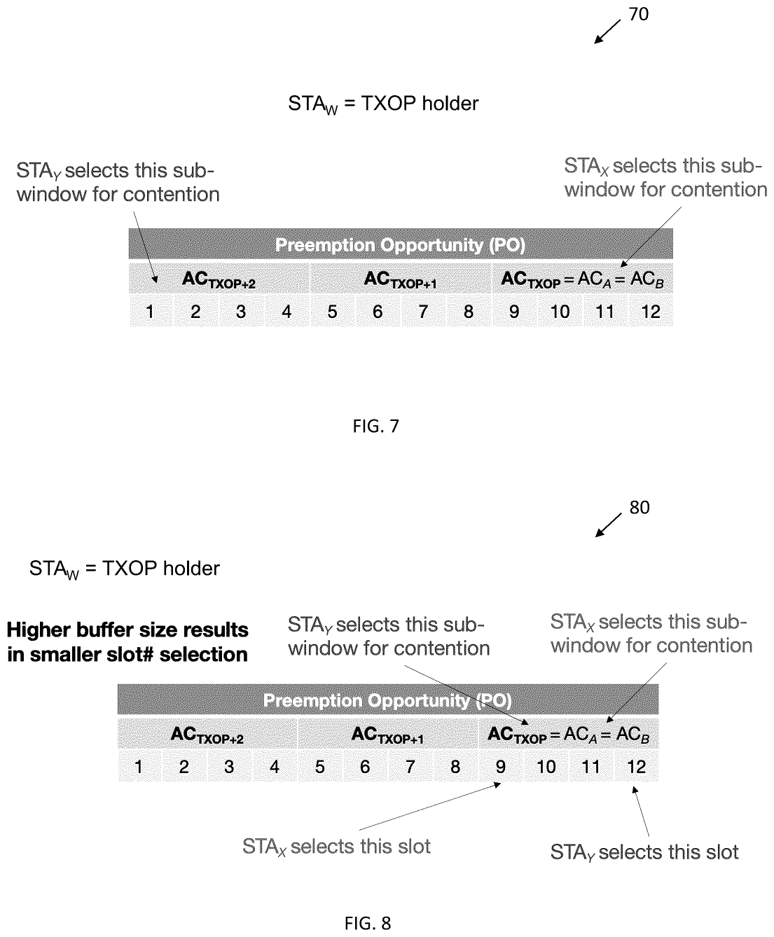

Referring now to FIG. 7, an example 70 of sub-window selection is provided. In the example 70, each sub-window is used by STAs whose AC corresponds to the AC of the sub-window, allowing for separation of the contention slots used by STAs in PES, depending on the AC of their traffic. In the example 70, STA_{W} is the TXOP holder. The AC of STA_{W} is AC_{A}. The two STAs, namely STA_{X} and STA_{Y}, have AC values greater than or equal to AC_{A}. Thus, the PESs may include STA_{X} with b1 frames corresponding to AC_{B}=AC_{A} and STA_{Y} with b2 frames corresponding to AC_{C}=AC_{A}+2.

Referring now to FIG. 8, an example 80 of sub-window selection is provided. To select a timeslot in each sub-window, STAs may utilize various metrics such as the amount of data buffered, allowing STAs with more buffered data to select smaller time slots. In the example 80, STA_{W} is the TXOP holder. The AC of STA_{W} is AC_{A}. The two STAs, namely STA_{X} and STA_{Y}, have AC values greater than or equal to AC_{A}. Thus, the PESs may include STA_{X} with b1=78/80 frames corresponding to AC_{B}=AC_{A} and STA_{Y} with b2=10/80 frames corresponding to AC_{B}. The buffer of STA_{X} is 97.5% (78/80) full, and the buffer of STA_{Y} is 12.5% (10/80) full. In this example, the maximum buffer capacity is 80 packets, frames, bytes, and/or other entities.

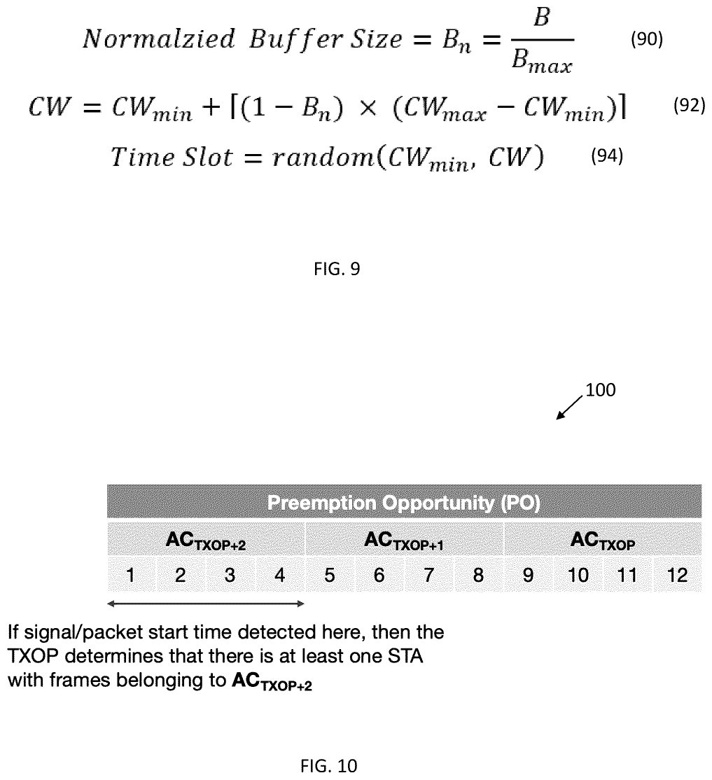

Referring now to FIG. 9, a set of example equations 90, 92, and 94 for selecting a timeslot in a sub-window is provided. In some examples, using equations 90, 92, and 94, a timeslot in a sub-window may be selected, where B is the buffer size at the STA, B_{MAX} is the maximum buffer capacity, CW_{MIN} is the lower threshold of the sub-window slot number, and CW_{MAX} is the upper threshold of the sub-window slot number.

In some examples for selecting a timeslot in a sub-window, a random number may be selected and the number may be decremented per timeslot and/or per PO. In some examples for selecting a timeslot in a sub-window, the timeslot may be selected randomly. In some examples for selecting a timeslot in a sub-window, the timeslot may be selected using a probability distribution function.

In some examples, a method for determining the number of timeslots in at least one sub-window (e.g., each sub-window) is provided. For example, the number of slots per sub-window may be calculated dynamically, depending on factors such as the number of STAs, the traffic rate, and/or the collision intensity.

In some examples, an example method for determining the number of timeslots in at least one sub-window (e.g., each sub-window) relies on the AP. The AP may calculate the number of STAs and percentage of traffic that belongs to each AC. For example, the AP can collect such information based on the history of traffic as well as periodic buffer status reports (BSRs). The AP may share this information with STAs via packets such as beacons. For example, if the total number of slots in the PO is known, at least one STA (e.g., each STA) may calculate the number of slots per sub-window. The total number of time slots in each PO may be determined by the TXOP holder, the AP, and/or as a fixed number of values depending on traffic type and/or rate.

In some examples, a method for adjusting the number of sub-windows dynamically based on collision intensity is provided. Referring now to FIG. 10, a representation 100 of adjusting the number of sub-windows dynamically based on collision intensity is provided. For example, if a collision is detected after a PO, traffic with the same or higher AC priority may exist. As shown in FIG. 10 the detection of a signal or a packet start time causes the TXOP holder to determine that there is at least one STA with frames in the corresponding AC. The TXOP holder may thus determine the highest AC of the competing STAs based on the start time of detecting a signal and/or packet on a channel, as shown in the representation 100.

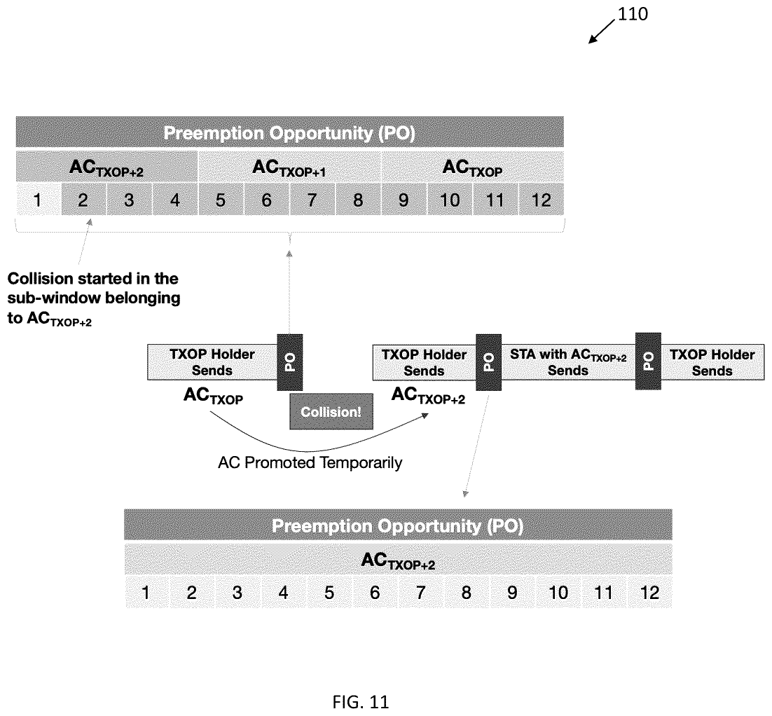

Referring now to FIG. 11, an example collision scenario 110 is provided. The TXOP holder may detect one or more collisions, for example, if a signal is sensed but no packet capture occurs afterwards. Depending on the start time of signal arrival, the TXOP holder may determine the type of traffic the STAs in the PESs may be sending. For example, detecting a collision that starts in time slot 2 may indicate that there are at least two STAs in PES whose AC are AC_{TXOP+2}.

Using this information, the TXOP holder may perform two operations. First, as soon as the channel is sensed idle (e.g., after collision), the TXOP holder may acquire the channel, transmit one or more frames, and/or mark the next PO. Second, through changing the AC of the frame being sent, the TXOP holder may allow the STAs in PES with AC_{TXOP+2} to use a larger number of times slots.

In the example collision scenario 110, the TXOP holder may determine that collision occurred in the sub-window belonging to AC_{TXOP+2}. The TXOP holder may acquire the channel as soon as the collision is over (e.g., when channel becomes idle). The TXOP holder may thus increase the AC of its traffic from AC_{TXOP} to AC_{TXOP+2}, resulting in allocating the whole PO duration to AC_{TXOP+2}, indicating that a larger number of time slots is available for the STAs with traffic belonging to AC_{TXOP+2}. This allows at least one of these STAs to win the contention and send its traffic after the next PO.

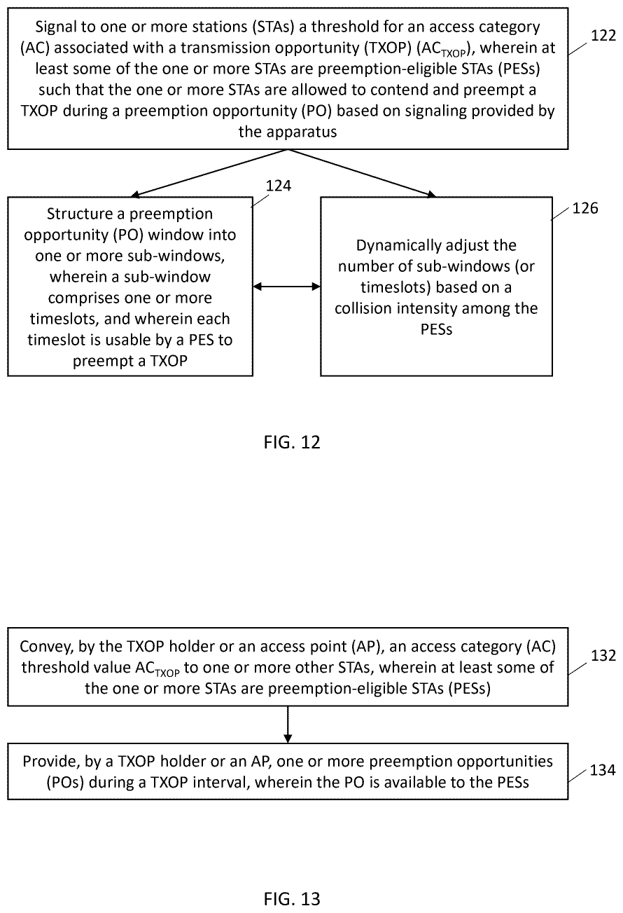

Referring now to FIG. 12, an example method implemented by one or more apparatuses described herein is provided. Although shown sequentially, the operations of FIG. 12 may be performed separately or in any combination. Thus, the method of FIG. 12 may include the performance of any one or more of the operations depicted in blocks 122, 124 and 126. As shown in block 122, the method includes signaling to one or more stations (STAs) a threshold for an access category (AC) associated with a transmission opportunity (TXOP) (ACTXOP), wherein at least some of the one or more STAs are preemption-eligible STAs (PESs) such that the one or more STAs are allowed to contend and preempt a TXOP during a preemption opportunity (PO) based on signaling provided by the apparatus. As shown in block 124, in one example a PO window may be structured into one or more sub-windows, wherein a sub-window comprises one or more timeslots, and wherein each timeslot is usable by a PES to preempt a TXOP. As shown in block 126, in another example, the number of sub-windows and/or timeslots may be dynamically adjusted based on a collision intensity among the PESs. Specific embodiments associated with the implementation of the method of FIG. 12 are provided in the embodiments of FIGS. 13-15.

Referring now to FIG. 13, an example method implemented by one or more apparatuses described herein is provided. As shown in block 132, a TXOP holder and/or an AP may convey an AC threshold value AC_{TXOP} to one or more other STAs, wherein at least some of the one or more STAs are preemption-eligible STAs (PESs). As shown in block 134, a TXOP and/or an AP may provide one or more preemption opportunities (POs) during a TXOP interval, wherein the PO is available to the PESs.

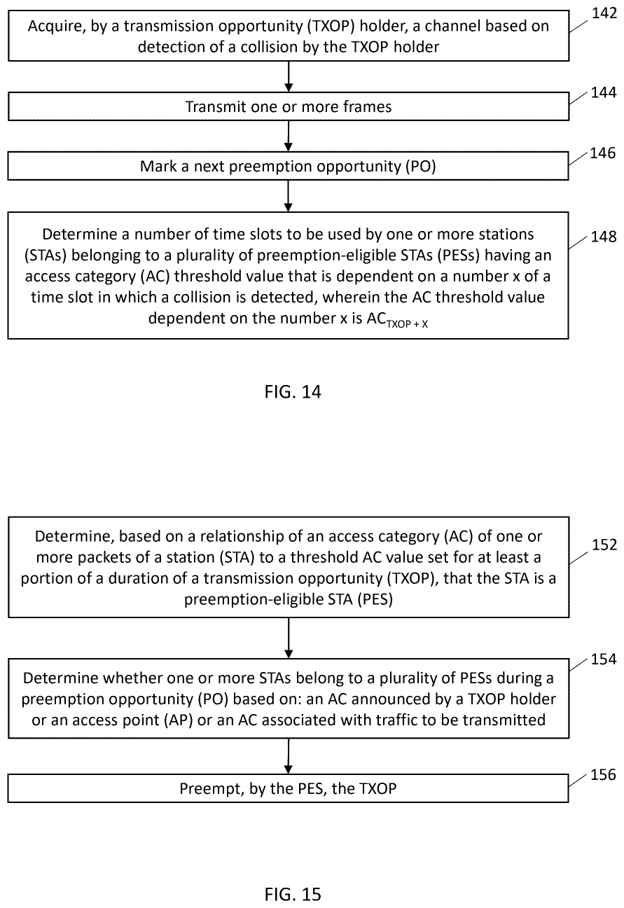

Referring now to FIG. 14, an example method implemented by one or more apparatuses described herein is provided. As shown in block 142, a TXOP holder may acquire a channel based on detection of a collision by the TXOP holder. As shown in block 144, one or more frames may be transmitted. As shown in block 146, a next PO may be marked. As shown in block 148, a number of timeslots may be determined, wherein the timeslots are to be used by one or more STAs belonging to a plurality of PESs having an AC threshold value that is dependent on a number x of a time slot in which a collision is detected, wherein the AC threshold value dependent on the number x is AC_{TXOP+X}.

Referring now to FIG. 15, an example method implemented by one or more apparatuses described herein is provided. As shown in block 152, it may be determined that a STA is a PES based on a relationship of an AC of one or more packets of the STA to a threshold AC value set for at least a portion of a duration of a TXOP. As shown in block 154, it may be determined whether one or more STAs belong to a plurality of PESs during a PO based on at least one of: (1) an AC announced by a TXOP holder or an AP, or (2) an AC associated with traffic to be transmitted. As shown in block 156, the PES may preempt the TXOP.

As described above, a method and apparatus are disclosed for dynamic channel access mechanisms for TXOP preemption, for example, where the apparatus may be the device 20 and the method may be any one of the methods of FIGS. 12-15. One or more operations recited in FIGS. 13-15 (e.g., all operations recited in FIGS. 13-15 or a subset of the operations recited in FIGS. 13-15) may be specific embodiments for performing the method of FIG. 12.

FIGS. 12-15 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present disclosure and executed by a processor. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims.

Moreover, although the foregoing descriptions and the associated drawings describe certain example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
at least one processor; and
at least one memory storing instructions that, when executed by the at least one processor, cause the apparatus at least to perform at least one of the following:
signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus;
structuring a PO window into one or more sub-windows, wherein a sub-window comprises one or more timeslots, and wherein each timeslot is usable by a PES to preempt a TXOP; or
dynamically adjusting, based on a collision intensity among the PESs, at least one of the following:
the threshold for the AC_{TXOP};
a number of sub-windows; or
a number of timeslots.

2. The apparatus according to claim 1, wherein the apparatus is a TXOP holder.

3. The apparatus according to claim 1, wherein the instructions, when executed by the at least one processor, further cause the apparatus to structure the PO window into one or more sub-windows by:
conveying, by the TXOP holder or an access point (AP), an access category (AC) threshold value AC_{TXOP} to one or more other STAs, wherein at least some of the one or more STAs are PESs; and
providing, by a TXOP holder or an AP, one or more POs during a TXOP interval, wherein a PO is available to the PESs.

4. The apparatus according to claim 1, wherein the instructions, when executed by the at least one processor, further cause the apparatus to dynamically adjust the number of sub-windows or timeslots by:
acquiring, by the TXOP holder, a channel based on detection of a collision by the TXOP holder;
transmitting one or more frames;
marking a next PO; and
determining a number of timeslots to be used by one or more STAs belonging to a plurality of PESs having an AC threshold value that is dependent on a number x of a time slot in which the collision is detected, wherein the AC threshold value dependent on the number x is AC_{TXOP+X}.

5. The apparatus according to claim 1, wherein the instructions, when executed by the at least one processor, further cause the apparatus to determine one or more STAs as PESs by:
determining, based on a relationship of an AC of one or more packets of a STA to a threshold AC value set for at least a portion of a duration of a TXOP, that the STA is a PES;
determining whether one or more STAs belong to a plurality of PESs during a PO based on:
an AC announced by a TXOP holder or an AP; or
an AC associated with traffic to be transmitted; and
preempting, by the PES, the TXOP.

6. An apparatus comprising:
at least one processor; and
at least one memory storing instructions that, when executed by the at least one processor, cause the apparatus at least to perform:
conveying, by a transmission opportunity (TXOP) holder or an access point (AP), an access category (AC) threshold value AC_{TXOP} to one or more other stations (STAs), wherein at least some of the one or more STAs are preemption-eligible STAs (PESs); and
providing, by a TXOP holder or an AP, one or more preemption opportunities (POs) during a TXOP interval, wherein the PO is available to the PESs.

7. The apparatus according to claim 6, wherein the PESs among the one or more other STAs are determined based on the AC_{TXOP} and the determining is performed by the TXOP holder or the AP based on received information or by the one or more STAs.

8. The apparatus according to claim 6, wherein a maximum AC is AC_{MAX} and wherein one or more POs include AC_{MAX}−AC_{TXOP}+1 sub-windows.

9. The apparatus according to claim 6, wherein one or more PESs determine, based on their AC values, which sub-window can be used for TXOP preemption.

10. The apparatus according to claim 8, wherein one or more of the AC_{MAX}−AC_{TXOP}+1 sub-windows are not equal to one another.

11. The apparatus according to claim 8, wherein one or more of the AC_{MAX}−AC_{TXOP}+1 sub-windows include one or more time slots for channel access contention.

12. The apparatus according to claim 8, wherein one or more of the AC_{MAX}−AC_{TXOP}+1 sub-windows are used by STAs having packets whose AC corresponds to the one or more of the AC_{MAX}−AC_{TXOP}+1 sub-windows.

13. The apparatus according to claim 6, wherein the instructions, when executed by the at least one processor, further cause the apparatus to calculate a number of sub-windows in one or more POs based on at least one of the following:
the TXOP holder or the AP conveying AC_{TXOP} to the one or more other STAs; or
the one or more other STAs having an indication of AC_{MAX}.

14. The apparatus according to claim 6, wherein the instructions, when executed by the at least one processor, further cause the apparatus to select one or more time slots in one or more sub-windows based on a priority or amount of buffered data.

15. The apparatus according to claim 6, wherein the TXOP holder is configured to announce a highest AC of its traffic as the AC_{TXOP}.

16. The apparatus according to claim 6, wherein the AP is configured to announce and enforce the AC_{TXOP} to be followed by all STAs by including such an announcement in beacon frames.

17. The apparatus according to claim 6, wherein the instructions, when executed by the at least one processor, further cause the apparatus to:
acquire, by the TXOP holder, a channel;
transmit one or more frames;
mark a next PO; and
determine, based on detection by the TXOP holder of a collision, a number of sub-windows and a number of timeslots to be used by one or more STAs belonging to a plurality of PESs having an AC threshold value that is dependent on a number x of a time slot in which the collision is detected, wherein the AC threshold value dependent on the number x is AC_{TXOP+X}.

18. The apparatus according to claim 6, wherein the instructions, when executed by the at least one processor, further cause the apparatus to set a lowest AC threshold value AC_{TXOP} that can be used for transmissions by the PESs.

19. An apparatus comprising:
at least one processor; and
at least one memory storing instructions that, when executed by the at least one processor, cause the apparatus at least to perform:
acquiring, by a transmission opportunity (TXOP) holder, a channel based on detection of a collision by the TXOP holder;
transmitting one or more frames;
marking a next preemption opportunity (PO); and
determining a number of sub-windows and a number of timeslots to be used by one or more stations (STAs) belonging to a plurality of preemption-eligible STAs (PESs) having an access category (AC) threshold value that is dependent on a number x of a time slot in which the collision is detected, wherein the AC threshold value dependent on the number x is AC_{TXOP+X}.

20. The apparatus according to claim 19, wherein the detection of the collision is based on a start time of signal arrival indicating a type of traffic that the one or more STAs belonging to the plurality of PESs are trying to send.

21. The apparatus according to claim 19, wherein the instructions, when executed by the at least one processor, further cause the apparatus to:
determine, by the TXOP holder, that the collision occurred in a sub-window associated with AC_{TXOP+X};
increase, by the TXOP holder, AC_{TXOP} to AC_{TXOP+X}; and
allocate, by the TXOP holder, an entire PO duration to AC_{TXOP+X} or allocate, by the TXOP holder, an entire PO duration to AC_{MAX}−AC_{TXOP+X}+1 sub-windows.

22. The apparatus according to claim 19, wherein an access point (AP) is configured to determine the number of timeslots based on a number of the one or more STAs and on an amount of traffic belonging to one or more ACs based on at least one of: buffer status reports (BSRs) or traffic exchange history.

23. The apparatus according to claim 22, wherein the one or more STAs belonging to the plurality of PESs are configured to calculate a number of timeslots per sub-window based on a total number of time slots in a current PO being known.

24. The apparatus according to claim 23, wherein a total number of timeslots in one or more POs is determined by at least one of the following:
the TXOP holder;
the AP; or
based on a fixed number of values depending on number of STAs, traffic type, and traffic rate.

25. The apparatus according to claim 19, wherein the instructions, when executed by the at least one processor, further cause the apparatus to determine, by the TXOP holder, a highest AC of one or more competing STAs based on a start time of detecting a signal or packet on the channel.

26. An apparatus comprising:
at least one processor; and
at least one memory storing instructions that, when executed by the at least one processor, cause the apparatus at least to perform:
determining, based on a relationship of an access category (AC) of one or more packets of a station (STA) to a threshold AC value (AC_{TXOP}) set for at least a portion of a duration of a transmission opportunity (TXOP), that the STA is a preemption-eligible STA (PES);
determining whether the apparatus belongs to a plurality of PESs during a preemption opportunity (PO) based on:
the threshold AC AC_{TXOP} announced by a TXOP holder or an access point (AP); or
an AC associated with traffic to be transmitted by the apparatus; and
preempting, by the apparatus, the TXOP.

27. The apparatus according to claim 26, wherein the instructions, when executed by the at least one processor, further cause the apparatus to set a lowest AC threshold value AC_{TXOP} that can be used for transmissions by the PES.

28. The apparatus according to claim 26, wherein the instructions, when executed by the at least one processor, further cause the apparatus to promote an AC or priority level associated with traffic based on slack time of packet delivery being reduced.

29. A method comprising at least one of:
signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus;
structuring a PO window into one or more sub-windows, wherein a sub-window comprises one or more timeslots, and wherein each timeslot is usable by a PES to preempt a TXOP; or
dynamically adjusting, based on a collision intensity among the PESs, at least one of the following:
the threshold for the AC_{TXOP};
a number of sub-windows; or
a number of timeslots.

30. A non-transitory computer readable storage medium comprising computer instructions that, when executed by an apparatus, cause the apparatus to perform at least one of:
signaling to one or more stations (STAs) a threshold for an access category (AC) associated with a transmission opportunity (TXOP) (AC_{TXOP}), wherein at least some of the one or more STAs are preemption-eligible STAs (PESs) such that the one or more STAs are allowed to contend and preempt a TXOP during a preemption opportunity (PO) based on signaling provided by the apparatus;
structuring a PO window into one or more sub-windows, wherein a sub-window comprises one or more timeslots, and wherein each timeslot is usable by a PES to preempt a TXOP; or
dynamically adjusting, based on a collision intensity among the PESs, at least one of the following:
the threshold for the AC_{TXOP};
a number of sub-windows; or
a number of timeslots.
